(19) United States
(12) Patent Application Publication
(10) Pub. No.: US 2003/0134624 A1
(43) Pub. Date: Jul. 17, 2003

(54) Remote access of call information and messages using wireless device connected to wireless network

(76) Inventor: Louis Robert Litwin, Plainsboro, NJ (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/046,460

(22) Filed: Jan. 16, 2002

(51) Int. Cl. H04B 1/38

(52) U.S. Cl. 455/415; 455/556; 455/566

(57) ABSTRACT

There is provided a method for remotely accessing caller ID information and messages from a caller ID/answering machine using a wireless device connected to a combination of wired and wireless networks. A connection is established from the wireless device to the caller ID/answering machine (305). A request for the caller ID information and/or the messages is transmitted from the wireless device to the caller ID/answering machine using a modem of the wireless device and another modem of the caller ID/answering machine, respectively (310). The caller ID information and/or the messages is transmitted from the caller ID/answering machine to the wireless device using the modems, in response to the request (320). The caller ID information and/or the messages are/is received by the wireless device (325). At least the caller ID information is stored in the wireless device for subsequent display, when the caller ID information is received (330).

### BACKGROUND

1. Technical Field

The present invention generally relates to mobile communications and, in particular, to the remote access of call information and messages using a wireless device connected to a wireless network.

2. Background Description

Conventional answering machines typically allow users to playback previously recorded voice messages. In such a case, the users call their home number and play back their messages using DTMF tones from a phone keypad to issue commands to the answering machine. However, conventional answering machines do not allow a user to retrieve caller ID information (date, time, caller number, caller name), nor do they allow for the retrieval of information for a call during which no message was left (but the user might still like to know the date and time of the call and the number and name of the caller). Also, messages can only be played back while on the phone with the answering machine, and they cannot be heard later after the connection with the answering machine is broken.

Accordingly, it would be desirable and highly advantageous to have a method and/or system for remotely retrieving caller ID information and messages. The method and/or system should allow for the remote retrieval of the caller ID information irrespective of whether a caller has left a message for the callee.

### SUMMARY OF THE INVENTION

The problems stated above, as well as other related problems of the prior art, are solved by the present invention, which provides remote access to call information (e.g., caller ID information) and messages using a wireless device connected to a wireless network. In particular, the present invention allows a user to remotely communicate with his or her home caller ID/answering machine in order to download and playback call information and messages using a wireless device with a connection to a wireless network (e.g., cellular phone network).

By downloading the information to the wireless device, the user can see/listen to the messages and caller ID information at his or her leisure and does not need to be connected to a network (the user could be on a plane, for example) to listen to the information since it is downloaded and stored locally on the user's wireless device. Also, the user can access caller ID information for missed calls which currently cannot be done in existing products.

According to aspect of the present invention, there is provided a method for remotely accessing caller ID information and messages from a caller ID/answering machine using a wireless device connected to a combination of wired and wireless networks. The method comprising the step of establishing a connection from the wireless device to the caller ID/answering machine. A request for at least one of the caller ID information and the messages is transmitted from the wireless device to the caller ID/answering machine using a modem of the wireless device and another modem of the caller ID/answering machine, respectively. The at least one of the caller ID information and the messages is transmitted from the caller ID/answering machine to the wireless device using the other modem of the caller ID/answering machine and the modem of the wireless device, in response to the request. The at least one of the caller ID information and the messages is received by the wireless device. At least the caller ID information is stored in the wireless device for subsequent display, when the caller ID information is received.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram of a computer processing system 100 to which the present invention may be applied according to an illustrative embodiment thereof;

FIG. 2 is a block diagram illustrating a communication system 200 to which the present invention may be applied, according to an illustrative embodiment of the present invention; and

FIG. 3 is a flow diagram illustrating a method for remotely accessing caller ID information and messages from a caller ID/answering machine using a wireless device connected to a combination of wired and wireless networks, according to an illustrative embodiment of the present invention.

### DETAILED DESCRIPTION OF PREFERRED EMBODIMENTS

The present invention is directed to the remote access of call information (e.g., caller ID information) and messages using a wireless device connected to a wireless network. According to an illustrative embodiment of the present invention, a user can call his or her home answering machine from a wireless device such as a cellular phone and the caller ID and messages will be downloaded onto the cellular phone for playback at a later time (even when the cell phone is not connected to a network).

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

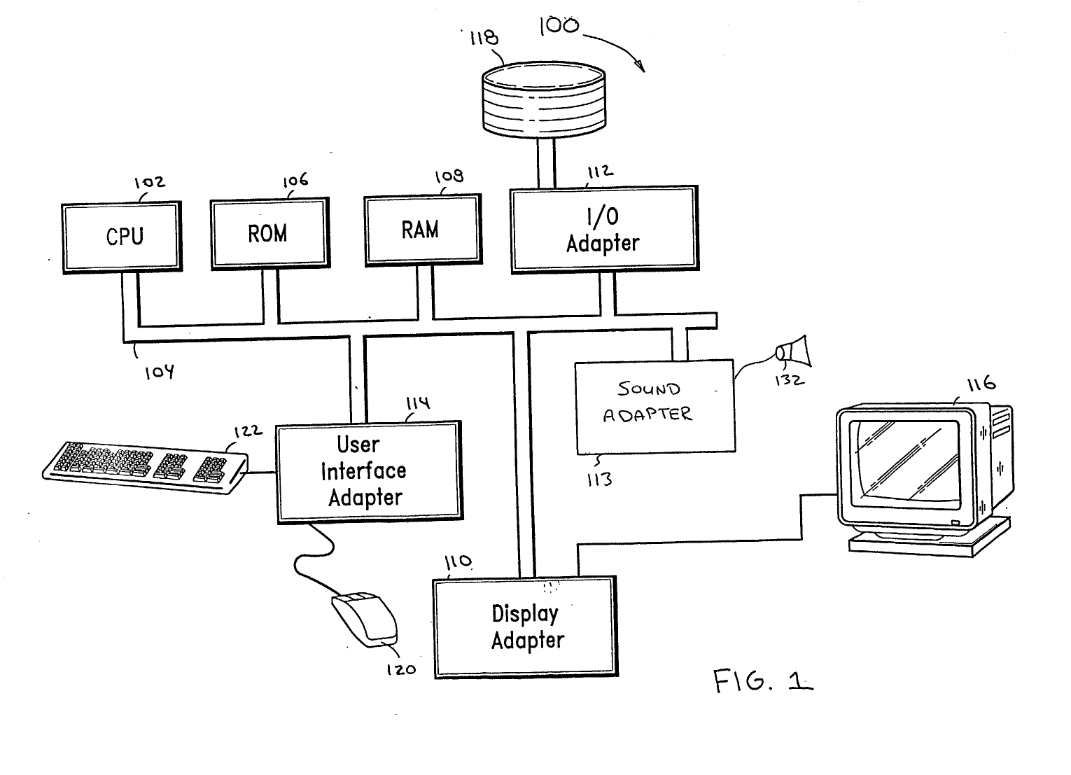

FIG. 1 is a block diagram of a computer processing system 100 to which the present invention may be applied according to an illustrative embodiment thereof. The computer processing system 100 includes at least one processor (CPU) 102 operatively coupled to other components via a system bus 104. A read only memory (ROM) 106, a random access memory (RAM) 108, a display adapter 110, an I/O adapter 112, a sound adapter 113, and a user interface adapter 114 are operatively coupled to the system bus 104.

A display device 116 is operatively coupled to the system bus 104 by the display adapter 110. A disk storage device (e.g., a magnetic or optical disk storage device) 118 is operatively coupled to the system bus 104 by the I/O adapter 112.

A mouse 120 and keyboard 122 are operatively coupled to the system bus 104 by the user interface adapter 114. The mouse 120 and keyboard 122 may be used to input/output information to/from the computer processing system 100.

A speaker 132 is operatively coupled to the system bus 104 by the sound adapter 113. While the computer processing system 100 is shown in FIG. 1 as including one speaker 132, the present invention is not limited to the same and, thus, more than one speaker (or none) may be included in the computer processing system 100. Moreover, it is to be appreciated that given the teachings of the present invention provided herein, one of ordinary skill in the related art will contemplate various other configurations and implementations of the elements of the present invention, including those shown in FIG. 1, while maintaining the spirit and scope of the present invention.

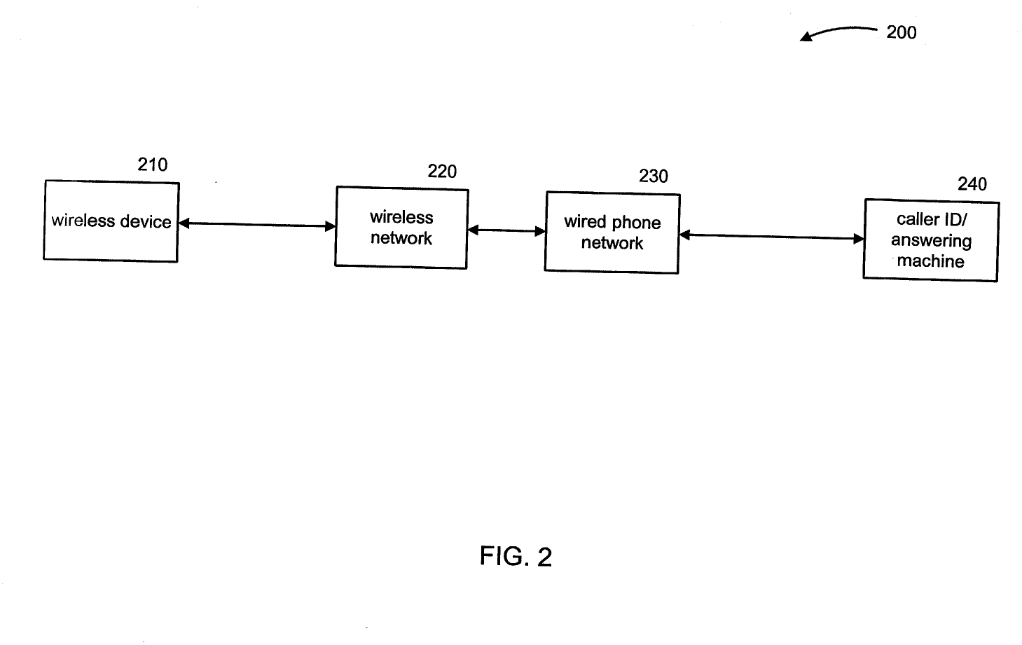

FIG. 2 is a block diagram illustrating a communication system 200 to which the present invention may be applied, according to an illustrative embodiment of the present invention. It is to be appreciated that many of the elements of the communication system 200 will have a computer processing system integrated therewith. Such a computer processing system is preferably the same or similar to (having one or more of the same or similar elements) that shown in FIG. 1. However, other variations of a computer processing system may be readily employed by one of ordinary skill in the related art, while maintaining the spirit and scope of the present invention.

The communication system 200 includes a wireless device 210; a wireless network (e.g., cellular phone or other wireless network) 220; a wired phone network 230; and a caller ID/answering machine 240.

The caller ID/answering machine 240 is located a the home, office, or other location corresponding to a user of the wireless device 210. It is to be appreciated that the caller ID/answering machine 240 may be comprised of a separate caller ID device and a separate answering machine, or may be an integrated device as shown in FIG. 2. Given the teachings of the present invention provided herein, one of ordinary skill in the related art will contemplate these and various other variations and configurations of the elements of FIG. 2, while maintaining the spirit and scope of the present invention.

The caller ID/answering machine 240 generates caller ID information for any calls to the user. The caller ID information may be generated by the caller ID/answering machine 240 irrespective of whether the caller leaves a message.

The wireless device 210 may be a cellular phone, wireless personal digital assistant (PDA), or other device having the functions necessary to implement the present invention as is readily ascertainable by one of ordinary skill in the related art.

The caller ID/answering machine 240 and the wireless device 210 each include internal modems 290. The modem 290 in the caller ID/answering machine 240 allows the caller ID/answering machine 240 to communicate over the networks 220, 230 with the wireless device 210. The modem 290 in the wireless device 210 allows the wireless device 210 to communicate over the networks 220, 230 with the caller ID/answering machine 240.

In one illustrative embodiment of the present invention, the wireless device 210 will be able to store and display call information (date, time, caller name, caller number) while only being able to play back messages while connected to the caller ID/answering machine 240. In another illustrative embodiment of the present invention, the wireless device 210 includes additional memory to also store the messages for later playback.

The wireless device 210 could provide the user with the capability to click on a caller ID entry on a list of entries to immediately call an individual corresponding to the caller ID entry.

In yet another illustrative embodiment of the present invention, the wireless device 210 could also connect to the caller ID/answering machine 240 directly over the wired phone network 230 by plugging it into a telephone wall jack; however, use of the a wireless network 220 greatly enhances the capabilities and flexibility of the present invention.

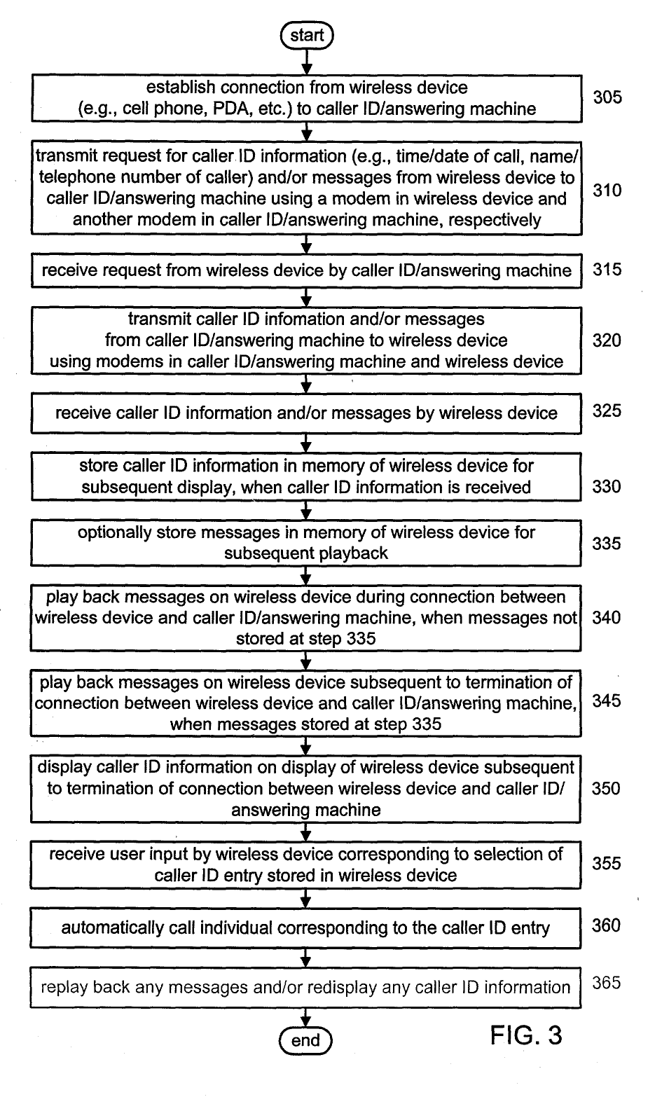

FIG. 3 is a flow diagram illustrating a method for remotely accessing caller ID information and messages from a caller ID/answering machine using a wireless device connected to a combination of wired and wireless networks, according to an illustrative embodiment of the present invention.

A connection is established from the wireless device 210 (e.g., cell phone, PDA, and so forth) to the caller ID/answering machine 240 (step 305). A request for the caller ID information (time of call, date of call, name of caller, and telephone number of caller) and/or the messages is transmitted from the wireless device 210 to the caller ID/answering machine 240 using a modem 290 of the wireless device 210 and another modem 290 of the caller ID/answering machine 240, respectively (step 310). The request is received from the wireless device 210 by the caller ID/answering machine 240 (step 315)

The caller ID information and/or the messages are transmitted from the caller ID/answering machine 240 to the wireless device 210 using the other modem 290 of the caller ID/answering machine 240 and the modem 290 of the wireless device 210, in response to the request (step 320). The caller ID information and/or the messages are received by the wireless device 210 (step 325). The caller ID information is stored in a memory of the wireless device 210 for subsequent display, when the caller ID information is received (step 330). Optionally, the messages are also stored in the memory of the wireless device 210 for subsequent playback (step 335).

If the messages are not stored at step 330, then the messages are played back on the wireless device 210, during the connection between the wireless device 210 and the caller ID/answering machine 240 (step 340). However, if the messages are stored at step 330, then the messages are played back on the wireless device 210, subsequent to a termination of the connection between the wireless device 210 and the caller ID/answering machine 240 (step 345). Of course, other arrangements, as readily determined by one of ordinary skill in the related, may also be employed while maintaining the spirit and scope of the present invention. For example, the messages may be stored at step 335, played back during the connection, and then replayed subsequent to the termination of the connection.

The caller ID information is displayed on a display of the wireless device 210, subsequent to a termination of the connection between the wireless device 210 and the caller ID/answering machine 240 (step 350). It is to be appreciated that anything stored in the wireless device 210 according to the present invention (e.g., the messages and/or the caller ID information) may be replayed back or redisplayed as many times as desired by a user of the wireless device 210.

A user input is received by the wireless device 210 corresponding to a selection of a caller ID entry stored in the wireless device 210 (step 355). An individual corresponding to the caller ID entry is automatically called (step 360).

Any of the messages and/or the caller ID information may be replayed back or redisplayed as desired by the user of the wireless device 210.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A method for remotely accessing caller ID information and messages from a caller ID/answering machine using a wireless device connected to a combination of wired and wireless networks, the method comprising the steps of:
establishing a connection from the wireless device to the caller ID/answering machine;
transmitting a request for at least one of the caller ID information and the messages from the wireless device to the caller ID/answering machine using a modem of the wireless device and another modem of the caller ID/answering machine, respectively;
transmitting the at least one of the caller ID information and the messages from the caller ID/answering machine to the wireless device using the other modem of the caller ID/answering machine and the modem of the wireless device, in response to the request;
receiving the at least one of the caller ID information and the messages by the wireless device; and
storing at least the caller ID information in the wireless device for subsequent display, when the caller ID information is received.

2. The method of claim 1, further comprising the step of storing the messages in the wireless device for subsequent playback.

3. The method of claim 1, further comprising the step of displaying the caller ID information on the wireless device, subsequent to a termination of the connection between the wireless device and the caller ID/answering machine.

4. The method of claim 1, further comprising the step of playing back the messages on the wireless device, subsequent to a termination of the connection between the wireless device and the caller ID/answering machine.

5. The method of claim 1, further comprising the step of playing back the messages on the wireless device, during the connection between the wireless device and the caller ID/answering machine.

6. The method of claim 1, further comprising the steps of:
receiving a user input by the wireless device corresponding to a selection of a caller ID entry stored in the wireless device; and
automatically calling an individual corresponding to the caller ID entry.

7. The method of claim 1, wherein the wireless device is a cellular phone.

8. The method of claim 1, wherein the wireless device is a personal digital assistant (PDA).

9. The method of claim 1, wherein the caller ID information comprises at least one of a time of a call, a date of the call, a name of a caller, and a telephone number of the caller.

10. The method of claim 1, wherein the combination of wired and wireless networks comprises a cellular phone network.

11. A system for remotely accessing caller ID information and messages using a combination of wired and wireless networks, the system comprising:
a caller ID/answering machine having a modem for receiving a request for at least one of the caller ID information and the messages and for transmitting the at least one of the caller ID information and the messages in response to the request; and
a wireless device having a modem for transmitting the request and for receiving the at least one of the caller ID information and the messages, and having a memory for storing at least the caller ID information for subsequent display when the caller ID information is received.

12. The system of claim 11, wherein the memory of said wireless device further stores the messages for subsequent playback.

13. The system of claim 11, wherein said handheld device further comprises a display for displaying the caller ID information, subsequent to a termination of a connection between the wireless device and the caller ID/answering machine.

14. The system of claim 11, further comprising at least one speaker for playing back the messages, subsequent to a termination of a connection between the wireless device and the caller ID/answering machine.

15. The system of claim 11, further comprising at least one speaker for playing back the messages, during a connection between the wireless device and the caller ID/answering machine.

16. The system of claim 11, wherein said wireless device is adapted to receive a user input corresponding to a selection of a caller ID entry stored in the wireless device and to automatically call an individual corresponding to the caller ID entry.

17. The system of claim 11, wherein the wireless device is a cellular phone.

18. The system of claim 11, wherein the wireless device is a personal digital assistant (PDA).

19. The system of claim 11, wherein the caller ID information comprises at least one of a time of a call, a date of the call, a name of a caller, and a telephone number of the caller.

20. The system of claim 11, wherein the combination of wired and wireless networks comprises a cellular phone network.
